(19) United States
(12) Patent Application Publication
(10) Pub. No.: US 2022/0026669 A1
(43) Pub. Date: Jan. 27, 2022

(54) A MACRO LENS ASSEMBLY

(71) Applicant: TH Swiss AG, Baar (CH)

(72) Inventor: Jongyoung PARK, Channgwon-si, Kyongsangnam-do (KR)

(21) Appl. No.: 17/311,716

(22) PCT Filed: Dec. 13, 2018
(86) PCT No.: PCT/EP2018/084815

§ 371 Date: Jun. 8, 2021

(51) Int. Cl. G02B 9/34

(52) U.S. Cl. CPC G02B 9/34

(57) ABSTRACT

A macro lens assembly and camera objectives. The macro lens assembly (10) comprises, in order from an object side (5) to an image plane side (6), a first group (1) of lenses having a positive refractive power, a second group (2) of lenses having a positive refractive power, a third group (3) of lenses having a negative refractive power and a fourth group (4) of lenses having a positive refractive power. The first group (1), the second group (2) and the fourth group (4) are fixed while the third group (3) is moveable with respect to the first, second and fourth groups such that a focus is adjustable by moving the third lens group (3).

The present invention is directed to a macro lens assembly and camera objectives especially as claimed in the independent claims.

Macro lens systems, capable of close up photographing, as for example disclosed in U.S. Pat. No. 8,681,435 usually have a plurality of lens groups, wherein typically two or more lens groups are moveable.

EP3226054 discloses endoscope lens systems for proximity magnifying observation. An optical system may comprise (in order from an object side) a first lens group having a positive refractive power, a second lens group having a negative refractive power and third lens group having a positive refractive power, wherein focusing is carried out by moving the second lens group.

It is an object of the present invention to overcome the draw-backs of the state of the art, in particular it is an object to provide a lens assembly which can be produced cost efficiently and which nevertheless has a stable performance, preferably at an 1:1 magnification.

The objects are solved with the invention as defined in the claims.

A macro lens assembly for a camera comprises a first group of lenses having a positive refractive power, a second group of lenses having a positive refractive power, a third group of lenses having a negative refractive power and a fourth group of lenses having a positive refractive power, in order from an object side to an image plane side.

The lens assembly is contained in a housing and has a mechanical and optionally an electric and electronic interface for connection with a camera.

Each group of lenses comprises at least one lens.

The first group, the second group and the fourth group are fixed. Thus the distance between the respective groups remains constant. The third group is moveable with respect to the other groups, such that a focus is adjustable by moving the third lens group.

The distance between the second and third group and thereby also the distance between the third group and the fourth group can be changed.

Hence only the third lens group is used for focusing which allows a construction of the lens assembly with reasonable costs.

Preferably the macro lens assembly enables taking pictures from infinity to a 1:1 magnification.

Preferably the macro lens assembly is a telephotographic macro lens assembly.

For a lens assembly of the telephoto type, the macro lens system has an overall positive refractive power. Usually a lens group with a negative refraction power is used as a field flattener to correct the curvature of the image field.

In this case the performance is maximized by placing a lens group with a positive refraction power close to the image plane.

The macro lens system may satisfy the expression

$$0 \cdot 6 \leq \frac{{f}_{4}}{{f}_{∞}} \leq 0 \cdot 7 ,$$

wherein f₄ denotes the focal length of the fourth group of lens, which is placed close to the image plane and wherein f_{∞} denotes the overall focal length of the assembly at in infinite object distance.

Preferably the fourth group of lens comprises more than one lens.

In particular the macro lens system may satisfy the expression

$$0 \cdot 6 \leq \frac{{f}_{last}}{{f}_{∞}} \leq 0 \cdot 8 ,$$

wherein fₗₐₛₜ denotes the focal length of the lens of the fourth group which is placed most closely to the image plane.

The above mentioned ratio may be achieved by a specific curvature of the last lens.

In a beneficial embodiment of the invention the macro lens system satisfies the expression

$$- 20 \leq \frac{{R}_{last}}{{f}_{∞}} \leq - 10 ,$$

wherein Rₗₐₛₜ denotes the curvature of the lens of the fourth group which is placed most closely to the image plane.

Advantageously the assembly is configured for forming an image of an object an infinite distance when the third group is placed most closely to the second group, and for acting as a macro lens, preferably with magnification of −1, when the third group is placed most closely to the fourth group.

The moveable third group may change the magnification of the macro lens system according to a changed object distance.

In particular the assembly satisfies the expression

$$0 \cdot 95 \leq \frac{{EP}_{∞}}{{EP}_{macro}} \leq 1 \cdot 05 ,$$

wherein EP_{∞} denotes the entrance pupil of the widest aperture at infinity and EP_{macro} denotes the entrance pupil of the widest aperture at minimum focal distance.

Regularly apertures or stops move in macro systems. For the assembly according to the present invention, preferable the aperture or stop, in particular arranged between the first and the second group of lens, does not move.

Hence, there is no change in the entrance pupil and EP_{∞} is more or less equal to EP_{macro}.

Advantageously the assembly satisfies the expression

$$- 0 \cdot 4 \leq \frac{{f}_{3}}{{f}_{∞}} \leq - 0 \cdot 3 ,$$

wherein f₃ denotes the focal length of the third lens group.

Advantageously the assembly satisfies the expression

$$0 \cdot 7 \leq \frac{{f}_{1}}{{f}_{∞}} \leq 0 \cdot 9 ,$$

wherein f₁ denotes the focal length of the first lens group.

Advantageously the assembly satisfies the expression

$$0 \cdot 5 \leq \frac{{f}_{2}}{{f}_{∞}} \leq 0 \cdot 6 ,$$

wherein f₂ denotes the focal length of the second lens group.

The conditions provide for minimizing a performance change when the focal distance is changed from infinity to a minimum focal distance.

In a preferred embodiment of the invention the assembly does not comprise any aspherical lens. Hence the assembly may be constructed without cost intensive elements.

Preferably the macro lens assembly has an overall focal length at in infinite object distance of f_{∞} greater than 50 mm, preferably greater or equal 150 mm.

In a beneficial embodiment of the macro lens assembly the aperture is arranged between the first lens group and second lens group. In particular the aperture is not moveable and hence the first lens group, the aperture and the second lens group form a fixed unit.

In an advantageous embodiment of the macro lens assembly the first lens group includes two cemented lens, each comprising two lens.

At least one of the two cemented lens may comprise a negative lens.

The first lens group may comprise two further single lens, wherein preferably one is arranged between the cemented lens.

The second lens group may consist only of one lens.

In an advantageous embodiment of the macro lens assembly the third lens group includes a cemented lens, the cemented lens comprising two lens.

The third lens group may comprise one further lens.

The object according to the inventions is also solved by a camera objective comprising a macro lens assembly as described above.

The objective with a macro lens assembly as described herein provides the advantages of the assemblies described herein.

The description is in the following described with reference to schematic drawings, which show non-limiting examples of the invention.

The figures schematically show:

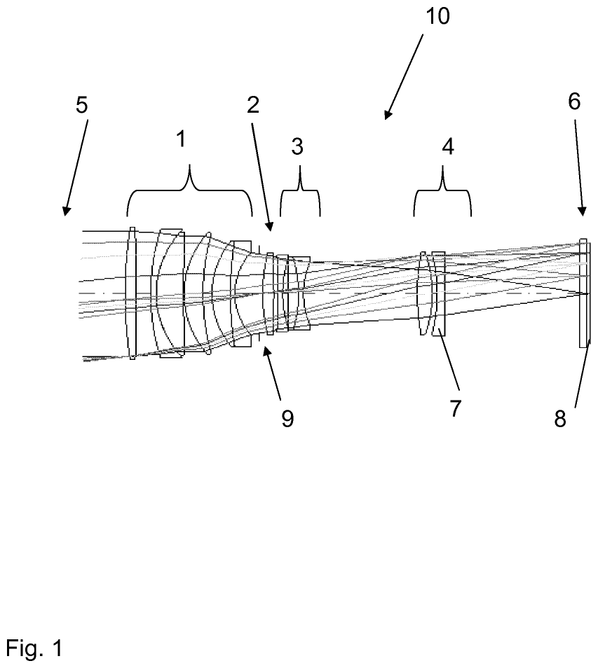

FIG. 1: A macro lens assembly according to the invention in a first position;

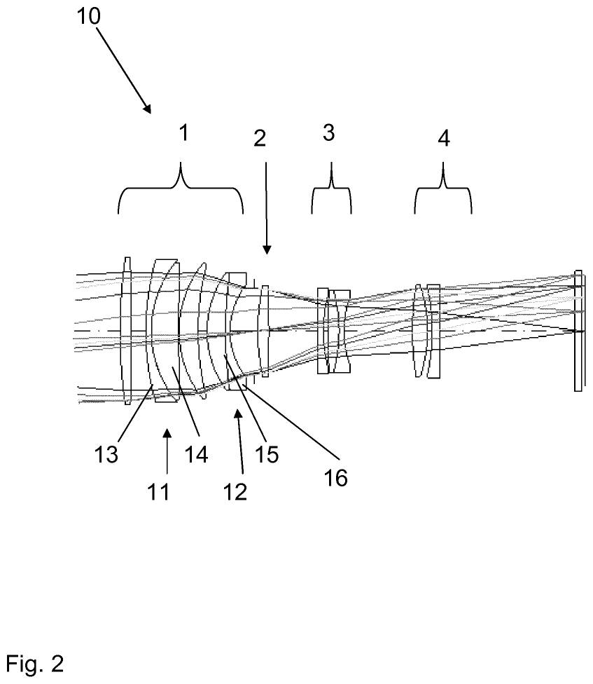

FIG. 2: The macro lens assembly according to the invention in a second position;

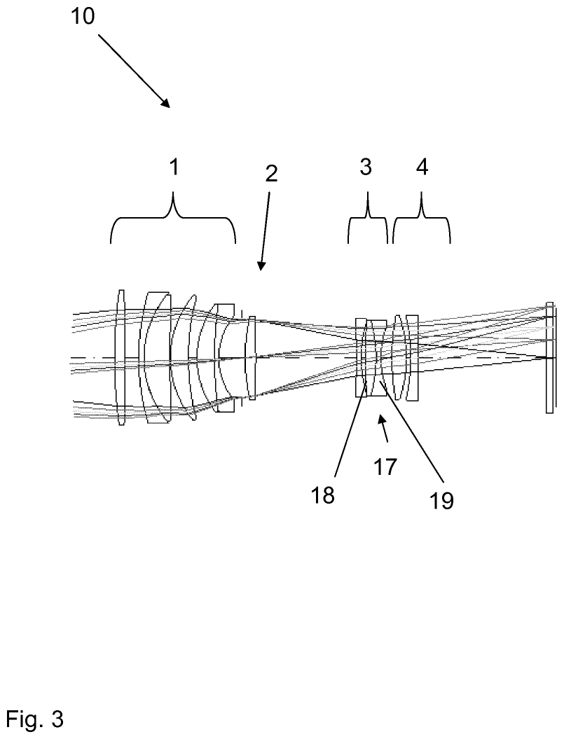

FIG. 3: The macro lens assembly according to the invention in a third position;

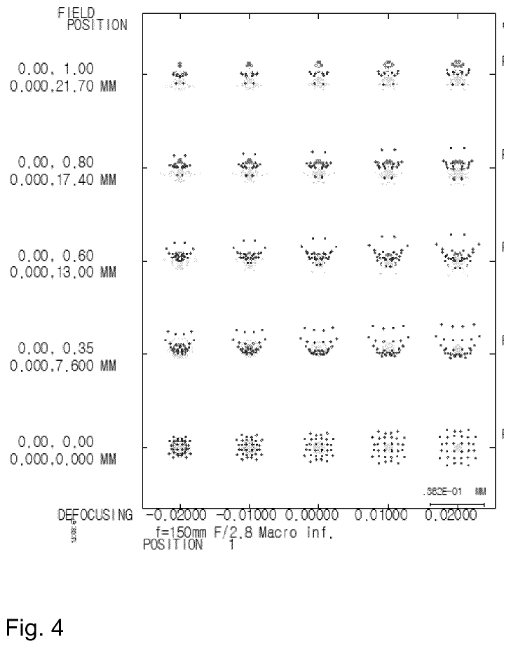

FIG. 4: A spot diagram of the embodiment of FIG. 1 at infinity;

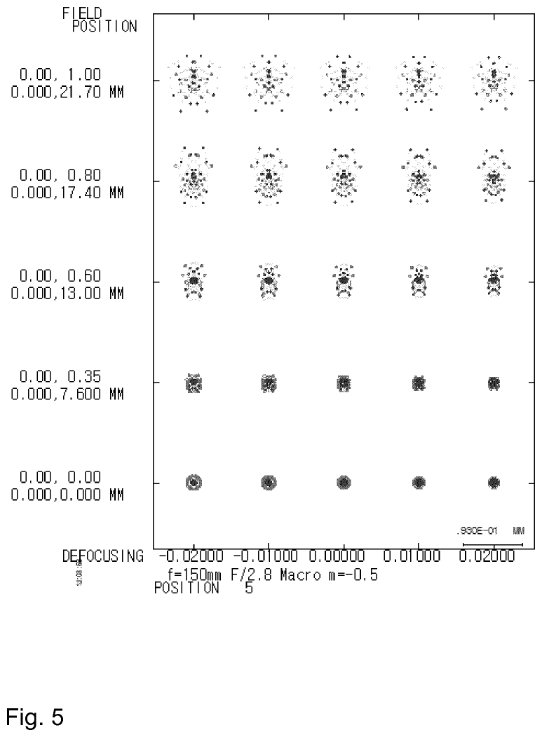

FIG. 5: A spot diagram of the embodiment of FIG. 2 with a magnification of −0.5;

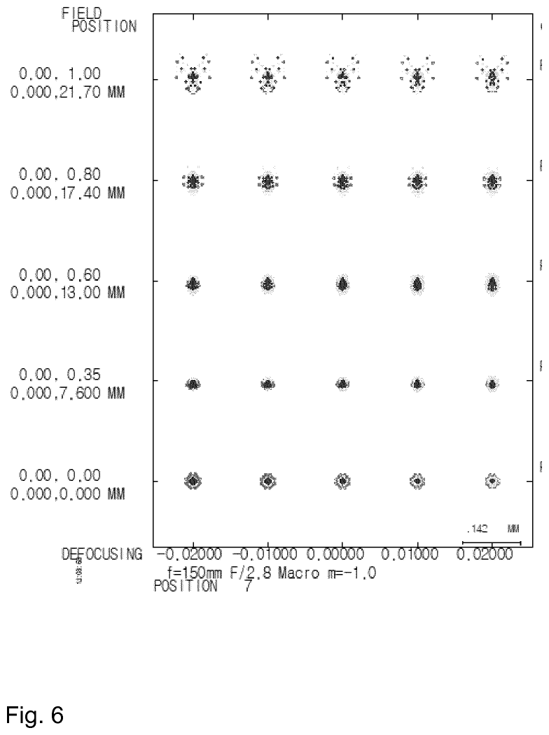

FIG. 6: A spot diagram of the embodiment of FIG. 3 with a magnification of −1;

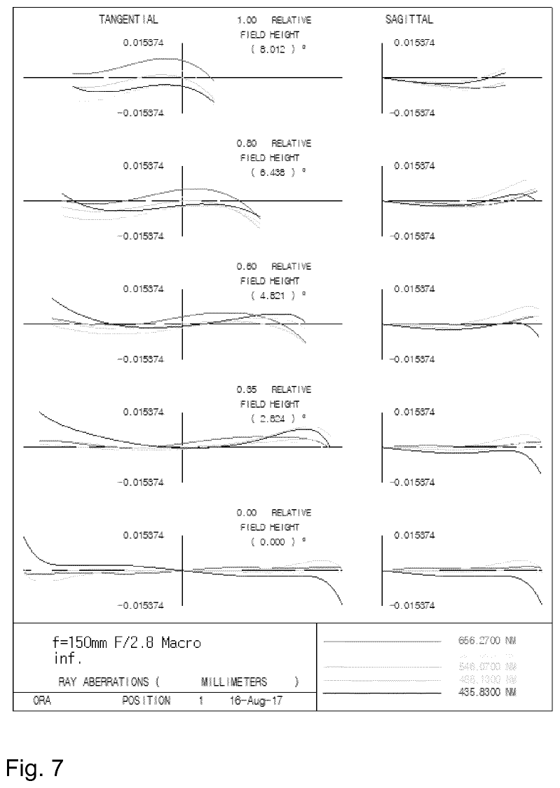

FIG. 7: A Ray Fan of the embodiment of FIG. 1 at infinity;

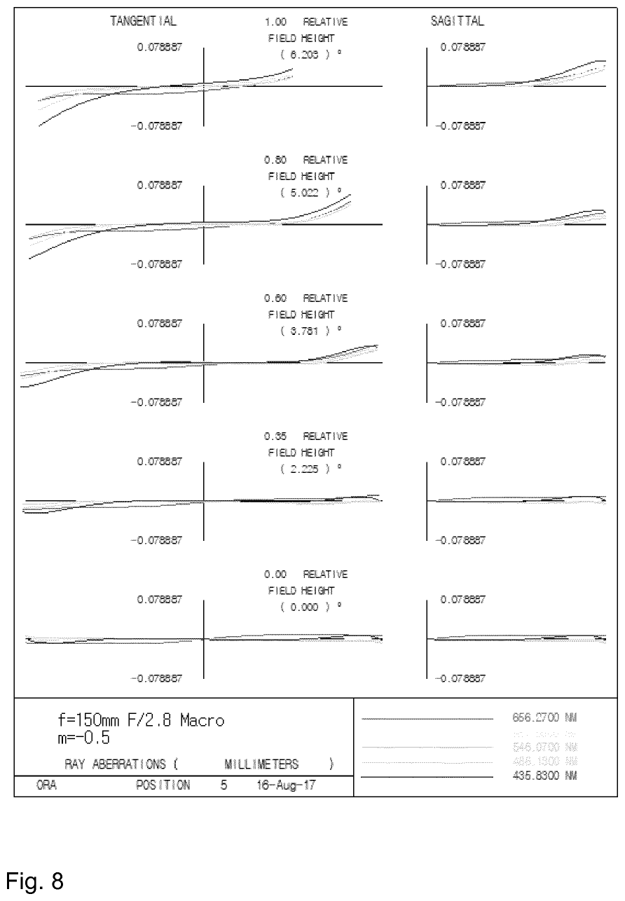

FIG. 8: A Ray Fan of the embodiment of FIG. 2 with a magnification of −0.5;

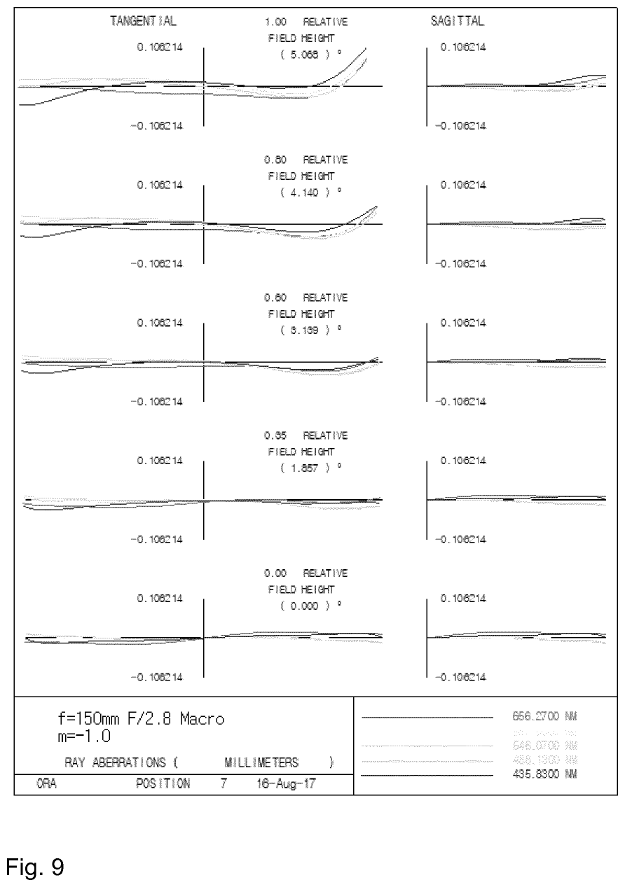

FIG. 9: A Ray Fan of the embodiment of FIG. 3 with a magnification of −1;

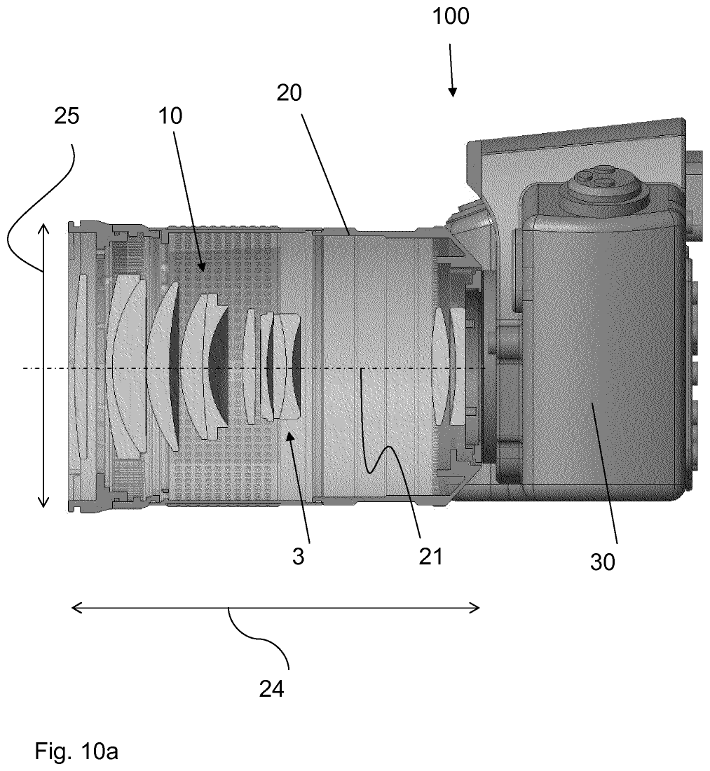

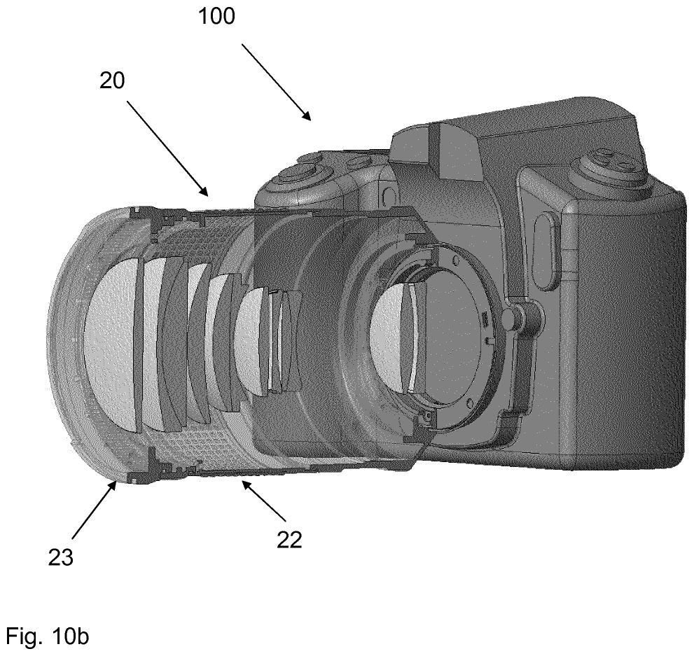

FIG. 10a: A schematic representation of a camera comprising a camera objective with a macro lens assembly in a side view;

FIG. 10b: A schematic representation of the camera according to FIG. 10a in a perspective view.

FIG. 1 shows a macro lens assembly 10 according to the invention in a first position.

The macro lens assembly 10 comprises a first group 1 of lenses having a positive refractive power, a second group 2 of lenses having a positive refractive power, a third group 3 of lenses having a negative refractive power and a fourth group 4 of lenses having a positive refractive power, in order from an object side 5 to the side 6 of the image plane 8.

The first group 1, the second group 2 and the fourth group 4 are fixed and the third group 3 is moveable with respect to the other groups, such that a focus is adjustable by moving the third lens group 3.

An aperture 9 is arranged between the first lens group 1 and second lens group 2. The aperture 9 may comprise 11 rounded blades.

In a first position the third group 3 is placed most closely to the second group 2, such that an image of an object an infinite distance may be formed.

A camera with a macro lens assembly 10 in the first position has an angle of view of 16.02°.

FIG. 2 shows a macro lens assembly 10 according to the invention in a second position, wherein the third group 3 has an intermediate position between the second group 2 and the forth group 4, such that a magnification of −0.5 is achieved.

The first lens group 1 includes two cemented lens 11, 12, each comprising two lens 13, 14, 15, 16.

One of the cemented lenses 12 comprises a negative lens 16.

A camera with a macro lens assembly 10 in the second position has an angle of view of 10.134°.

FIG. 3 shows a macro lens assembly 10 according to the invention in a third position, wherein the third group 3 is positioned close to the forth group 4.

The first group 1 and the second group 2 remain at a fixed position.

The third lens group 3 includes a cemented lens 17. The cemented lens 17 comprises two lens 18, 19.

A camera with a macro lens assembly 10 in the third position has an angle of view of 12.4°.

Typical specifications representing a first embodiment of the assembly of FIGS. 1-3 are disclosed in the following tables.

TABLE 1
Specifications of embodiment 1
f = 150 mm Fno = 2.8

| No | Radius | Thickness | Glass | Note |
|---|---|---|---|---|
| Object | Infinity | THI 0 | | |
| 1 | 217.164 | 3.82 | BACD16 | Group 1 |
| 2 | −3303.608 | 5.47 | | |
| 3 | 104.875 | 2.00 | FDS24 | |
| 4 | 43.768 | 10.00 | FCD1 | |
| 5 | 2462.170 | 0.10 | | |
| 6 | 43.130 | 6.90 | EFDS1 | |
| 7 | 107.141 | 3.27 | | |
| 8 | 40.070 | 6.72 | FCD1 | |
| 9 | 167.936 | 1.60 | FD60 | |
| 10 | 29.588 | 8.69 | | |
| 11 (STOP) | infinity | 1.42 | | |
| 12 | 84.731 | 4.00 | TAF5 | Group 2 |
| 13 | −352.702 | 1.50zoom | | |
| 14 | −475.150 | 1.80 | TAFD45 | Group 3 |
| 15 | 55.492 | 1.73 | | (Moving) |
| 16 | 373.766 | 4.00 | EFDS1 | |
| 17 | −60.461 | 1.80 | FCD1 | |
| 18 | 39.390 | 41.37zoom | | |
| 19 | 110.255 | 5.46 | TAC8 | Group 4 |
| 20 | −60.582 | 1.76 | | |
| 21 | −80.256 | 3.00 | FDS90 | |
| 22 | −1804.797 | 48.98 | | |
| 23 | infinity | 2.5 | BK7 | Cover |
| 24 | infinity | 1.0 | | glass |
| 25 | infinity | 0.0 | | |

TABLE 2
Results for embodiment 1

| | Example | remarks |
|---|---|---|
| ƒ₁ | 129.23 | 1^{st} group focal |
| | | length |
| ƒ₂ | 83.64 | 2^{nd} group focal |
| | | length |
| ƒ₃ | −43.9 | 3^{rd} group focal |
| | | length |
| ƒ₄ | 98.3 | 4^{th} group focal |
| | | length |
| ƒₗₐₛₜ | 113.1 | Last lens focal |
| | | length |
| ƒ_{∞} | 154.0 | Entire lens focal |
| | | length |
| Rₗₐₛₜ | −1804.8 | Last lens curvature |
| EP_{∞} | 53.1 | Entrance pupil |
| EP_{macro} | 52.13 | Entrance pupil at |
| | | minimum |
| | | focal distance |
| $0.6 \leq \frac{{f}_{last}}{{f}_{∞}} \leq 0.8$ | 0.73 | Focal length pro- portion between entire lens and last lens |
| $0.7 \leq \frac{{f}_{1}}{{f}_{∞}} \leq 0.8$ | 0.84 | Focal length pro- portion between entire lens and 1^{st} lens group |
| $0.5 \leq \frac{{f}_{2}}{{f}_{∞}} \leq 0.6$ | 0.54 | Focal length pro- portion between entire lens and 2^{nd} lens group |
| $- 0.4 \leq \frac{{f}_{3}}{{f}_{∞}} \leq - 0.3$ | 0.28 | Focal length pro- portion between entire lens and 3^{rd} lens group |
| $0.6 \leq \frac{{f}_{4}}{{f}_{∞}} \leq 0.7$ | 0.63 | Focal length pro- portion between entire lens and 4^{th} lens group |
| $- 20 \leq \frac{{R}_{last}}{{f}_{∞}} \leq - 10$ | −11.7 | Curvature pro- portion between entire lens and last lens |
| $0.95 \leq \frac{{EP}_{∞}}{{EP}_{macro}} \leq 1.05 \qquad ( 4 )$ | 1.018 | Entrance pupil proportion between entire lens and macro |

FIGS. 4-6 show spot diagrams of the embodiment of FIG. 1 at different magnifications. FIG. 4 (third column) is related to the embodiment with the third lens group (3) in a first position as shown in FIG. 1. FIG. 5 (third column) is related to the embodiment with the third lens group (3) in a second position as shown in FIG. 2. FIG. 6 (third column) is related to the embodiment with the third lens group (3) in a third position as shown in FIG. 3.

The spot diagrams represent the intersections of rays from a given object point at a field position (y-axis) with an image plane at a “defocusing position” (x-axis) of the macro lens assembly. The spot diagrams provide an immediate visual indication of the imaging quality at that points.

At least for magnifications m=−0.5 (FIG. 5) and m=−1.0 (FIG. 6) the macro lens assembly shows excellent imaging characteristics for most of the positions.

FIG. 7 shows a Ray Fan of the embodiment of FIG. 1 at infinity. FIG. 8 shows a Ray Fan of the embodiment of FIG. 2 with a magnification of −0.5. FIG. 9 shows a Ray Fan of the embodiment of FIG. 3 with a magnification of −1.

FIG. 10a shows a schematic representation of a camera 100 comprising a camera body 30 and a camera objective 20 with a macro lens assembly 10 in a side view.

The camera 100 in particular is a digital photo camera, wherein the camera objective 20 can be exchanged.

The third lens group 3 is in a first position according to FIG. 1.

By turning a part of the camera objective 20 around the optical axis 21 the third lens group may be moved along the axis 21.

The camera objective 20 may have a length 24 of 100 mm-150 mm, in particular 128 mm, and a diameter 25 of 50 mm-110 mm, in particular 87 mm.

FIG. 10b shows a schematic representation of the camera 100 as shown in FIG. 10a in a perspective view.

The camera 100 may be a high resolution digital single lens reflex (DSLR) camera with am 35 mm “full image” format. The camera objective 20 may have an aperture range of f/2.8 mm-f/32 mm, which facilitates short exposure times.

A 1:1 macro reproduction ratio may be available at a focusing distance of 0.3 m-0.4 m, in particular 0.345 m.

High precision of focusing across the entire range may be ensured by the objective 20 comprising a wide focus ring 22 with an anti-slip coating, for example a rubber coating, having a rotational angle of 270°. An additional focus ring lock (not explicitly shown in the figures) may ensure that the focus position remains fixed when needed.

The front filter thread 23 may have diameter of 50 mm-90 mm, in particular 77 mm.

1-16. (canceled)

17. A macro lens assembly for a camera comprising, in order from an object side to an image plane side:
a first group of lenses having a positive refractive power,
a second group of lenses having a positive refractive power,
a third group of lenses having a negative refractive power, and
a fourth group of lenses having a positive refractive power,
wherein the first group, the second group and the fourth group are fixed and the third group is moveable with respect to the first, the second and the fourth groups, such that a focus is adjustable by moving the third lens group.

18. The macro lens assembly according to claim 17, wherein the macro lens system satisfies the expression:
$$0 \cdot 6 \leq \frac{{f}_{last}}{{f}_{∞}} \leq 0 \cdot 9 ,$$
wherein fₗₐₛₜ denotes a focal length of the lens of the fourth group which is placed most closely to the image plane, and
f_{∞} denotes an overall focal length of the assembly at in infinite object distance.

19. The macro lens assembly according to claim 17, wherein the macro lens system satisfies the expression:
$$0 \cdot 6 \leq \frac{{f}_{4}}{{f}_{∞}} \leq 0 \cdot 7 ,$$
wherein f₄ denotes a focal length of the fourth group of lens, which is placed close to the image plane, and
f_{∞} denotes an overall focal length of the assembly at an infinite object distance.

20. The macro lens assembly according to claim 17, wherein the macro lens system satisfies the expression:
$$- 20 \leq \frac{{R}_{last}}{{f}_{∞}} \leq - 10 ,$$
wherein Rₗₐₛₜ denotes a curvature of the lens of the fourth group which is placed most closely to the image plane, and
f_{∞} denotes an overall focal length of the assembly at an infinite object distance.

21. The macro lens assembly according to claim 17, wherein the assembly is configured for acting as a macro lens when the third group is placed close to the fourth group.

22. The macro lens assembly according to claim 17, wherein the assembly satisfies the expression:
$$0 \cdot 95 \leq \frac{{EP}_{∞}}{{EP}_{macro}} \leq 1 \cdot 06 ,$$
wherein EP_{∞} denotes an entrance pupil of a widest aperture at infinity, and
EP_{macro} denotes the entrance pupil of the widest aperture at a minimum focal distance.

23. The macro lens assembly according to claim 17, wherein the assembly satisfies the expression:
$$- 0.4 \leq \frac{{f}_{3}}{{f}_{∞}} \leq - 0 \cdot 3 ,$$
wherein f₃ denotes a focal length of the third lens group, and
f_{∞} denotes an overall focal length of the assembly at an infinite object distance.

24. The macro lens assembly according to claim 17, wherein the assembly satisfies the expression:
$$0 \cdot 7 \leq \frac{{f}_{1}}{{f}_{∞}} \leq 0 \cdot 9 ,$$
wherein f₁ denotes a focal length of the first lens group, and
f_{∞} denotes an overall focal length of the assembly at an infinite object distance.

25. The macro lens assembly according to claim 17, wherein the assembly satisfies the expression:
$$0 \cdot 5 \leq \frac{{f}_{2}}{{f}_{∞}} \leq 0 \cdot 6 ,$$
wherein f₂ denotes a focal length of the second lens group, and
f_{∞} denotes an overall focal length of the assembly at an infinite object distance.

26. The macro lens assembly according to claim 17, wherein the assembly does not comprise any aspherical lens.

27. The macro lens assembly according to claim 17, wherein the assembly has an overall focal length at an infinite object distance of f_{∞} greater than 50 mm.

28. The macro lens assembly according to claim 27, wherein the overall focal length, at an infinite object distance of f_{∞}, is greater than or equal 150 mm.

29. The macro lens assembly according to claim 17, wherein the aperture is arranged between the first lens group and the second lens group.

30. The macro lens assembly according to claim 17, wherein the first lens group includes two cemented lens, and each of the two cemented lens comprises two lens.

31. The macro lens assembly according to claim 30, wherein at least one of the cemented lens comprises a negative lens.

32. The macro lens assembly according to claim 17, wherein the third lens group includes a cemented lens, and the cemented lens comprising two lens.

33. A camera objective comprising the macro lens assembly according to claim 17.
